(19) United States
(12) Patent Application Publication
(10) Pub. No.: US 2007/0139580 A1
(43) Pub. Date: Jun. 21, 2007

(54) Flat panel display having shielding member

(75) Inventor: Xiang Zhang, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/644,101

(22) Filed: Dec. 21, 2006

(30) Foreign Application Priority Data
Dec. 21, 2005 (CN) 200510121041.7

(51) Int. Cl. G02F 1/1333

(52) U.S. Cl. 349/58

(57) ABSTRACT

An exemplary flat panel display (1) includes a display panel (11), a printed circuit board (12) located adjacent the display panel, a metallic chassis (13) covering the printed circuit board, and a shielding member (14) fixed to the chassis. The chassis and the display panel cooperatively define a gap therebetween. The shielding member is at least partly located in the gap.

### FIELD OF THE INVENTION

The present invention relates to flat panel displays (FPDs), and more particularly to a flat panel display having a shielding member located adjacent to a gap defined by a chassis and a display panel thereof.

### GENERAL BACKGROUND

Flat panel displays are commonly used as display devices for compact electronic apparatuses. Referring to FIG. 10, a typical flat panel display 8 includes a front frame 80, a display panel 81, a printed circuit board (PCB) 82, a chassis 83, a plurality of elastic gaskets 84, and a back cover 85. The front frame 80, the display panel 81, the PCB 82, and the chassis 83 are generally arranged in that order from left to right. The front frame 80 and the back cover 85 cooperatively define a space (not labeled) for accommodating the display panel 81, the PCB 82, the chassis 83, and the gaskets 85.

Typically, the PCB 82 radiates electromagnetic waves when in a working state, and these electromagnetic waves are liable to seriously interfere with the normal operation of electrical components/devices (not shown) around the flat panel display 8. Thus, the electromagnetic waves from the PCB 82 are generally called electro magnetic interference (EMI). Therefore, the PCB 82 is covered by the chassis 83 for shielding most of the EMI generated thereby. However, one or more gaps (not shown) generally exist between the chassis 83 and the display panel 81 for improving mechanical intensity of the chassis 83, which gaps provide a channel for the EMI to emit the chassis 83. Thus, the gaskets 85 are generally arranged in the gaps.

Referring also to FIG. 11, each gasket 85 includes a foaming core 852, a coat 854 generally surrounding the foaming core 852, and an adhesive tape 856 formed at an outer surface (not labeled) of the coat 854. Each gasket 85 can be adhered at a surface of the chassis 83 thus defining the corresponding gap. However, the adhesive tape 856 is prone to degrade over time, and the gasket 85 may fall off from the chassis 83 and be lost. Furthermore, the coat 854 of the gasket 85 is generally made from a plurality of slim metallic threads, which makes manufacturing of the gasket 85 complicated. This results in the gasket 85 being rather costly. The flat panel display 8 using the gaskets 85 is correspondingly costly.

What is needed, therefore, is a flat panel display that can overcome the above-described deficiencies.

### SUMMARY

In one preferred embodiment, a flat panel display includes a display panel, a printed circuit board located adjacent the display panel, a metallic chassis covering the printed circuit board, and a shielding member fixed to the chassis. The chassis and the display panel cooperatively define a gap therebetween. The shielding member is at least partly located in the gap.

Other aspects, advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of at least one embodiment of the present invention. In the drawings, like reference numerals designate corresponding parts throughout various views, and all the views are schematic.

FIG. 1 is an exploded, isometric view of a flat panel display according to a first embodiment of the present invention, the flat panel display including a chassis and a plurality of shielding members.

FIG. 2 is an enlarged, isometric view of the chassis of the flat panel display of FIG. 1.

FIG. 3 is an enlarged, inverted, isometric view of one of the shielding members of the flat panel display of FIG. 1.

FIG. 4 is similar to FIG. 3, but showing the shielding member viewed from another aspect.

FIG. 5 is similar to FIG. 2, but showing one of the shielding members of FIG. 1 being fixed to the chassis.

FIG. 6 is an enlarged, front view of a circled portion VI of FIG. 5.

FIG. 7 is an enlarged, back view corresponding to the circled portion VI of FIG. 5.

FIG. 8 is similar to FIG. 3, but showing a shielding member of a flat panel display according to a second embodiment of the present invention.

FIG. 9 is similar to FIG. 3, but showing a shielding member of a flat panel display according to a third embodiment of the present invention.

FIG. 10 is an exploded, isometric view of a conventional flat panel display, the flat panel display including a plurality of gaskets.

FIG. 11 is an enlarged, isometric view of one of the gaskets of the flat panel display of FIG. 10.

### DETAILED DESCRIPTION OF PREFERRED EMBODIMENTS

Reference will now be made to the drawings to describe the preferred embodiments in detail.

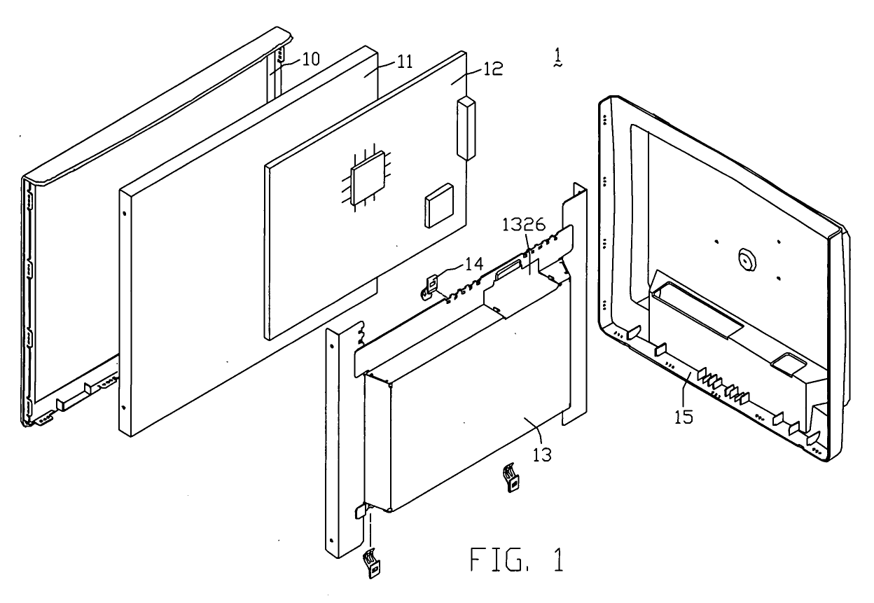

Referring to FIG. 1, a flat panel display 1 according to a first embodiment of the present invention is shown. The flat panel display 1 includes a front frame 10, a display panel 11, a PCB 12, a chassis 13, a plurality of shielding members 14, and a back cover 15. The front frame 10, the display panel 11, the PCB 12, and the chassis 13 are arranged generally in that order from left to right. The front frame 10 and the back cover 15 cooperatively define a first space (not labeled) for accommodating the display panel 11, the PCB 12, the chassis 13, and the shielding members 14.

The front frame 10 has a generally rectangular shape, and has a size which is slightly greater than a size of the display panel 11. The front frame 10 includes four side borders (not labeled) connected end to end, thus defining a window for allowing viewing of the display panel 11. The front frame 10 is preferably made from plastic, polymer, or another suitable material.

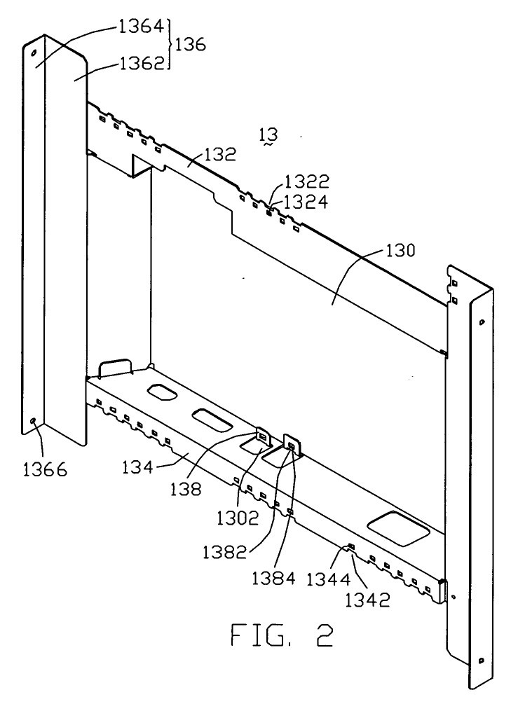

Referring also to FIG. 2, the chassis 13 includes an offset back wall 130, a first strip 132, a second strip 134, and two opposite location walls 136. The back wall 130 is essentially box-shaped. The back wall 130 defines a first opening (not labeled) at a front side thereof between the location walls 136, and defines a second space (not labeled) therein for receiving the PCB 12. The back wall 130 has a plurality of second openings 1302 at a bottom side (not labeled) thereof. Two location baffles 138 respectively extend from edges of two of the second openings 1302 toward the first strip 132. Each location baffle 138 has a first notch 1382 above the second opening 1302, and a first location hole 1384 above the respective first notch 1382. The chassis 13 is preferably made from iron, steel, aluminum, magnesium, a suitable alloy thereof, or another suitable alloy.

The first strip 132 upwardly extends from a top edge of the back wall 130. The first strip 132 defines a plurality of second notches 1322 at a top edge thereof, and a plurality of second location holes 1324 respectively below the second notches 1322. In the illustrated embodiment, the first strip 132 and a top side (not labeled) of the back wall 130 further cooperatively define a third opening (not labeled) corresponding to low voltage differential signaling (LVDS) wires (not shown) of the display panel 11. The third opening can be completely covered by a metallic shielding step 1326.

The second strip 134 downwardly extends from a bottom edge of the back wall 130, and is essentially parallel to the first strip 132. The second strip 134 defines a plurality of third notches 1342 at a bottom edge thereof, and a plurality of third location holes 1344 respectively above the third notches 1342. In the illustrated embodiment, the third location holes 1344 and the second location holes 1324 have the essentially same size; and there are more third location holes 1344 than second location holes 1324.

The location walls 136 are respectively connected with two vertical sides of the back wall 130. Each location wall 136 is essentially L-shaped, and includes a first wall 1362 and a second wall 1364. The first walls 1362 outwardly extend from the vertical sides of the back wall 130, respectively. The second walls 1364 perpendicularly extend from respective edges of the first walls 1362 toward the display panel 11. A distance between the second walls 1364 is slightly greater than a horizontal length of the display panel 11. The second side walls 1364 each define two threading holes 1366. The threading holes 1366 respectively correspond to two threading holes (not labeled) in two vertical sides of the display panel 11. That is, the second walls 1364 can be respectively threadingly engaged to the vertical sides of display panel 11.

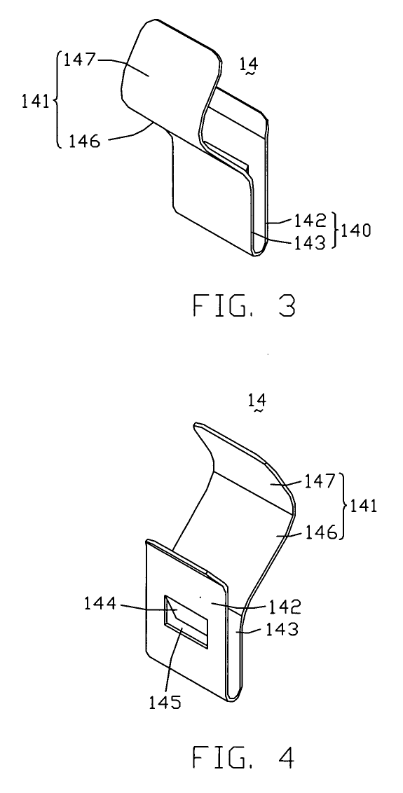

Referring to FIG. 3 and FIG. 4, the shielding member 14 includes a holding portion 140, and a contact portion 141 integrally extending from the holding portion 140. The holding portion 140 includes a first plate 142, a second plate 143, a curved connection plate (not labeled), and a tongue 144. The first plate 142 is essentially parallel to the second plate 144, and has a fourth opening 145 thereon. The tongue 144 integrally extends from an edge of the fourth opening 145 toward the second plate 143. The connection plate interconnects the first plate 142 and the second plate 143.

The contact portion 141 includes a third plate 146, and a fourth plate 147. The third plate 146 interconnects the fourth plate 147 and the second plate 143, and extends away from the first plate 142. The fourth plate 147 extends toward the first plate 142 from an edge opposite to the second plate 143 of the third plate 146. The first plate 142, the second plate 143, the connection plate, the third plate 146, and the fourth plate 147 have an essentially same width, and the width corresponds to that of the first notch 1382. The shielding member 14 is elastic, and is preferably made from tinplate.

The back cover 15 has a size essentially the same as that of the front frame 10, and defines two fourth notches 1502 respectively corresponding to two of the first notches 1302 of the chassis 13. The back cover 15 is preferably made from plastic, polymer, or another suitable material.

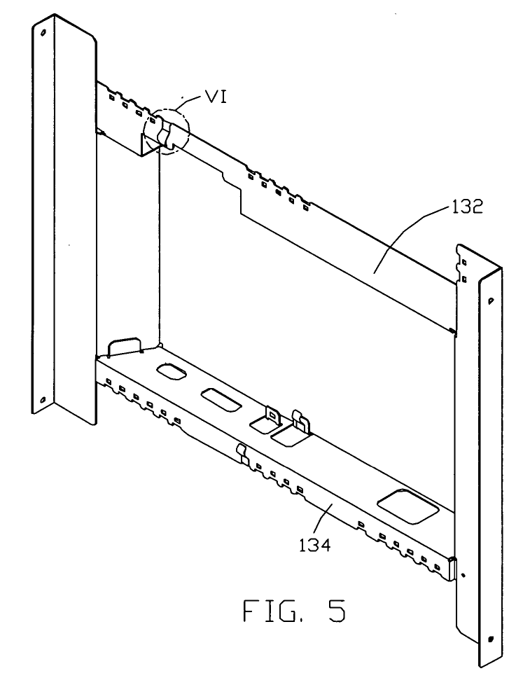

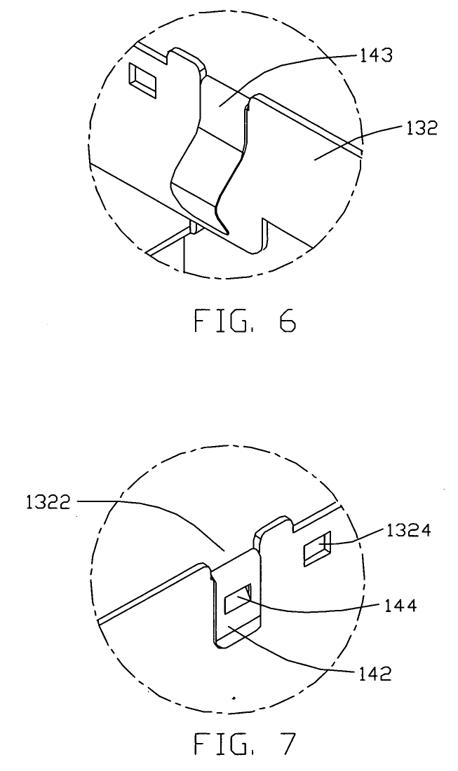

Referring to FIG. 5, FIG. 6 and FIG. 7, when the shielding member 14 is fixed to the first strip 132 of the chassis 13, the connection plate is received in the first notch 1322. The first plate 142 abuts an outer surface (not labeled) of the first strip 132, and the tongue 144 extends into one respective second location hole 1324 and is fixed therein. The second plate 143 abuts an inner surface (not labeled) of the first strip 132. An end of the contact portion 141 elastically abuts a bottom portion of the first strip 132. Therefore, the shielding member 14 is fixed to the first strip 132. The shielding members 14 can be similarly fixed to the second strip 134.

When the flat panel display 1 is assembled, a plurality of gaps (not shown) are defined between the display panel 11 and the first and second strips 132, 134. The shielding member 14 is fixed to the chassis 13, and is adjacent one corresponding gap, thereby absorbing any EMI passing therethrough. Thus, any EMI of the flat panel display 1 can be reduced or even eliminated.

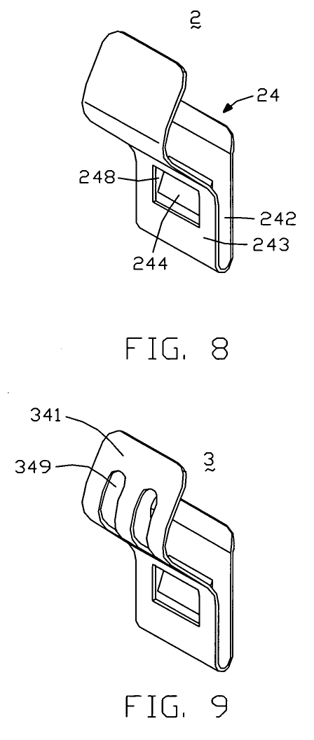

In FIG. 8, a shielding member 24 of a flat panel display 2 according to a second embodiment of the present invention similar to the shielding member 14 is shown. The shielding member 24 includes a first plate 242, a second plate 243, and a tongue 244. The tongue 244 extends from the first plate 242 toward the second plate 243. The second plate 243 has an opening 248 corresponding to the tongue 244. In the illustrated embodiment, a size of the opening 248 is essentially equal to that of the tongue 244. In a process of removing the shielding member 24 from a chassis (not shown) of the flat panel display 2, the opening 248 provides convenience for pressing the tongue 244 toward the first plate 242, thus conveniently removing the shielding member 24 from the chassis.

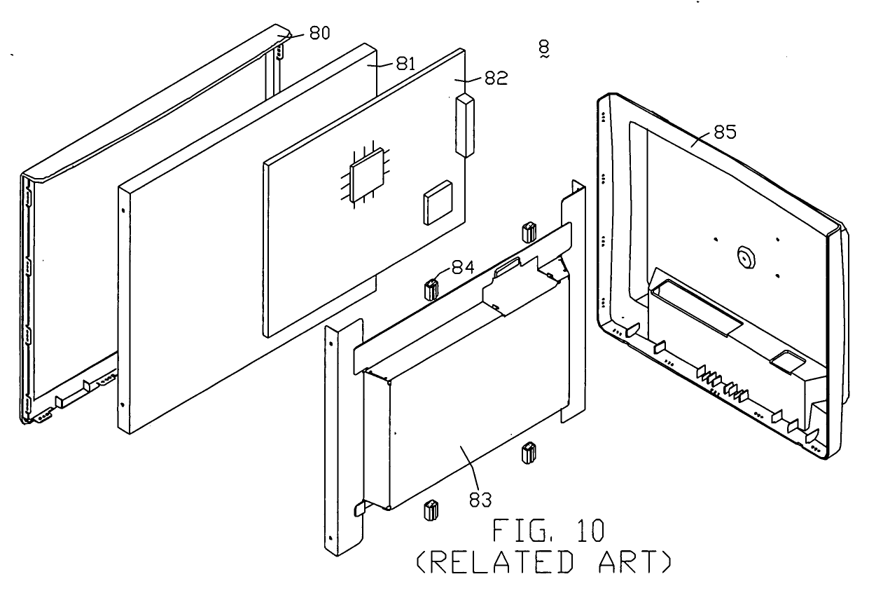

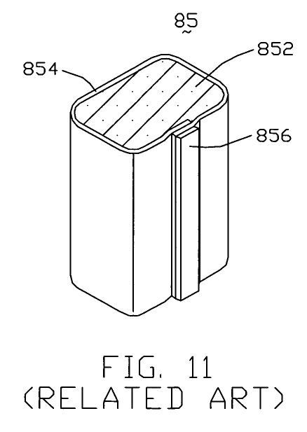

In FIG. 9, a shielding member 34 of a flat panel display 3 according to a third embodiment of the present invention similar to the shielding member 24 is shown. The shielding member 34 has a plurality of parallel openings 349 on a contact portion 341 thereof. In the illustrated embodiment, the shielding member 34 defines two openings 349. The openings 349 can enhance mechanical elasticity of the shielding member 34, such that the shielding member 34 can be fixed to a thicker chassis.

It is believed that the present embodiments and their advantages will be understood from the foregoing description, and it will be apparent that various changes may be made thereto without departing from the spirit or scope of the invention or sacrificing all of its material advantages, the examples hereinbefore described merely being preferred or exemplary embodiments of the invention.

What is claimed is:

1. A flat panel display comprising:
a display panel;
a printed circuit board located adjacent the display panel;
a metallic chassis covering the printed circuit board, wherein the chassis and the display panel cooperatively define a gap therebetween; and
a shielding member fixed to the chassis, the shielding member being at least partly located in the gap.

2. The flat panel display in claim 1, wherein the chassis comprises an offset back wall defining a space, the printed circuit board being received in the space.

3. The flat panel display in claim 2, wherein the chassis further comprises a strip extending from an edge of the back wall.

4. The flat panel display in claim 3, wherein the strip extends from a top edge of the back wall.

5. The flat panel display in claim 3, wherein the strip extends from a bottom edge of the back wall.

6. The flat panel display in claim 3, wherein the strip has a notch defined at an edge thereof.

7. The flat panel display in claim 6, wherein a location hole is further defined on the strip, the location hole being between the space and the notch.

8. The flat panel display in claim 6, wherein the shielding member comprises a holding portion and a contact portion extending from the holding portion.

9. The flat panel display in claim 7, wherein the holding portion comprises a first plate abutting an outer surface of the strip and a second plate abutting an inner surface of the strip.

10. The flat panel display in claim 9, wherein the holding portion further comprises a connection plate interconnecting the first plate and the second plate.

11. The flat panel display in claim 10, wherein the connection plate is received in the notch.

12. The flat panel display in claim 9, wherein the first plate has a first opening thereon.

13. The flat panel display in claim 12, wherein the holding portion further comprises a tongue extending from an edge of the first opening toward the second plate.

14. The flat panel display in claim 13, wherein the tongue is fixed in the through hole, thereby the shielding member is fixed to the strip.

15. The flat panel display in claim 13, wherein the second plate has a second opening thereon, the second opening corresponding to the tongue.

16. The flat panel display in claim 15, wherein the contact portion has a third opening thereon.

17. The flat panel display in claim 1, wherein the shielding member is elastic.

18. The flat panel display in claim 1, wherein the shielding member is made from tinplate.

19. A flat panel display comprising:
a display panel;
a printed circuit board located adjacent the display panel;
a metallic chassis covering the printed circuit board, wherein the chassis and the display panel cooperatively define a gap therebetween; and
a shielding member fixed to the chassis and defining a spring tang contacting the display panel.
